(19) United States
(12) Patent Application Publication
(10) Pub. No.: US 2004/0232584 A1
(43) Pub. Date: Nov. 25, 2004

(54) Testing of fabricated fluoropolymer articles for metal contamination

(76) Inventor: David William Johnson, Washington, WV (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/835,024

(22) Filed: Apr. 29, 2004

Related U.S. Application Data
(60) Provisional application No. 60/471,990, filed on May 20, 2003.

(51) Int. Cl. B29C 45/00

(52) U.S. Cl. 264/127; 264/328.1; 134/26

(57) ABSTRACT

The present invention relates to the melt fabrication of fluoropolymer into articles that are useful in semi-conductor manufacture and in transporting liquids, without contaminating the semi-conductor or the liquid with metal contamination arising from metal melt-fabrication equipment. To achieve this result, the article has a smooth surface characterized by an RMS roughness of no greater than 0.20 μm, so as not to retain metal contaminant.

### BACKGROUND OF THE INVENTION

1. Field of the Invention

This invention relates the melt-fabrication of articles of fluoropolymer in a manner to minimize metal contamination of the article.

2. Description of Related Art

While articles fabricated from various fluoropolymers have a wide range of utility, some articles when used in certain applications have the requirement that they not contaminate their surroundings with metal. The metal contamination can be in the form of elemental metal or metal compounds. Melt-fabrication of fluoropolymers, however, involves the use of metal-faced equipment such as injection molds and extrusion barrels and dies. Even though the melt-facing is chosen so as not to be reactive with or corroded by the thermoplastic resin at the elevated temperatures of melt-fabrication, some metal contamination of the fabricated article occurs. The metal contamination can be present on the surface of the article, arising from the metal surfaces of the fabrication equipment or can be present in the body of the article, arising from metal contamination present in the thermoplastic resin fed into the fabrication equipment. For example, such thermoplastic feed comes from polymerization in metal reactors and downstream processing in metal-faced equipment, such as melt extrusion to form molding pellets. Metal contamination present in the body of the article is thought to be subject to leaching out of the metal contaminant by the processing liquid contacting the article.

Articles melt-fabricated from fluoropolymers are used in the semiconductor industry to transport the semiconductor through liquid chemical processing steps and to store and transport the liquid chemicals used in the processing. Exclusion of metal contamination of semi-conductor and the liquid environment is critical. Permissible metal contamination levels (total of Ni, Cr, and Fe) in the bulk fluoropolymer prior to melt-fabrication into an article for semiconductor industry service should be no greater than 10 parts per billion (ppb) to be accepted by the semiconductor industry. It is expensive to attain this purity. U.S. Pat. No. 6,541,588 B1 discloses the fluorination of fluoropolymer prior to melt extrusion into pellets, otherwise the pellets have a Ni, Fe, and Cr content which exceeds 200 ppb. EP 1 162 212 discloses the formation of the fluoropolymer using ultra-high purity materials, i.e. having low metal content.

Testing of articles melt-fabricated from various fluoropolymers has been unable to confirm that this high purity fluoropolymer reduces metal contamination from the article melt-fabricated from the fluoropolymer, i.e. the use of high purity fluoropolymer does not reduce metal contamination arising from fluoropolymer articles in semiconductor manufacture. The semiconductor industry has recently developed a test for determining the metal contamination by an extruded article of fluoropolymer. The test is called SEMI F57-0301 and will be referred to herein as F57. The test protocol involves first the cleaning of the extruded article, and then soaking the cleaned extruded article, followed by determination of the metal concentration in the soaking liquid. The cleaning step is intended to remove metal contamination from the surface of the article, as would cleaning of the fluoropolymer article prior to placement into semiconductor manufacturing service, and the soaking step is intended to remove metal from the body (bulk) of the article, i.e. by leaching the metal out of the article. These steps are described in greater detail below. According to F57, the concentration of Ni, Cr, and Fe, the most common metals coming into contact with the molten fluoropolymer at least in the melt-fabrication operation, in the soaking liquid is required to be no greater than 1 microgram per square meter of article surface (ug/m²) for Ni and for Cr and no greater than 5 μg/m² for Fe.

The cleaning step involves filling of the article (tube) with ultra-pure water (metal concentration less than 0.1 ppb) and agitation of the water for 10 min, followed by discarding the water, and repetition of this cleaning step 10×, using a fresh charge of ultra-pure water each time. The soaking (leaching) step involves holding the article filled with ultra-pure water heated at 85+5° C. for 7 days. The premise of this protocol is that the leaching step will determine metal contamination only from the bulk of the article, the surface metal contamination having already been removed.

### BRIEF SUMMARY OF THE INVENTION

It has been found that notwithstanding the repetition and rigor of the cleaning step in the F57 test practiced on the melt fabricated article, not all the metal contamination present on the surface of the article is removed. Thus, the residual surface metal contamination is added to the leach contamination from the soaking step to give a misleading reading of high bulk contamination, even when the as-supplied fluoropolymer has extremely low metal contamination. It is known that smooth surfaces on melt-fabricated articles reduce entrapment of impurities, but melt fabrication practice in the field has not produced micro-smooth article surfaces. In melt extrusion for example, the rate of extrusion and thus production rate, is limited by the formation of melt fracture on the surface of the extruded article. The extrusion rate is reduced until the surface of the article is visually free of melt fracture, i.e., the surface appears clear and glossy. It has been found that this practice is not good enough; the surface of the article melt-extruded such that surface melt-fracture is not visible to the naked eye, nevertheless has microscopic surface defects that entrap metal contamination, which is not entirely removed by the cleaning step of the F57 contamination test. The same is true when the cleaning liquid is changed, such as to dilute nitric acid. Surprisingly, while the aqueous cleaning medium does entirely clean the smooth, glossy appearing portions of the surface of the molded article, the cleaning medium does not penetrate to the depths of the cracks and fissures present as micro-defects in the article surface to remove all the surface metal contamination, whereby the leaching step unearths the residual surface metal contamination, giving misleadingly high values of leachable metal contaminants.

The foregoing unexpected discoveries of the present invention lead to the carrying out of the contamination test with melt-fabricated articles having surfaces of improved surface smoothness so that the cleaning step removes all of the surface metal contamination and the leaching step gives a true reading of the metal contamination from the bulk of the molded article.

One embodiment of the present invention may be described as the process for determining metal contamination arising from an article melt-fabricated from fluoropolymer, said process comprising (a) subjecting said article to cleaning so as to remove said metal present on the surface of said article, (b) subjecting the resultant cleaned article to leaching solution, and (c) determining the concentration of said metal in the leaching solution, the surface of said article having smoothness characterized by an RMS (root mean square) roughness of no greater than about 0.2 μm, thereby facilitating the removal of the metal contamination from the surface of said article by said cleaning, whereby the concentration of said metal determined in step (c) is not affected by the said metal present on the surface of said article.

It has been found that even though the fluoropolymer has greater than 10 ppb of metal (the sum of Ni, Cr, and Fe) contamination, the leaching step uncovers acceptable levels of metal contamination in the leach solution, i.e. no more than about 1 μg/m² for Ni and for Cr and no more than about 5 μg/m² for Fe. Thus, according to the present invention, it is unnecessary to undertake the extra expense in fluoropolymer manufacture to produce ultra-pure fluoropolymer. It is only necessary that the article made from the fluoropolymer and used in semiconductor manufacture have the surface smoothness indicated above.

The melt-fabricated articles passing the contamination test give confidence that articles melt-fabricated the same way, preferably using the small-spherulite fluoropolymer, will provide contamination-free articles for such use as in semi-conductor processing or the transport of liquids. In that regard, the present invention can also be defined as a process for melt-fabricating fluoropolymer into an article, comprising, carrying out said melt-fabricating to obtain said article having a smoothness characterized by an RMS roughness of no greater than about 0.2 μm, whereby said article passes the F57 test. Since Ni, Cr and Fe are the most common metal contaminants in the fluoropolymer, if the concentration of these metals does not exceed the amounts mentioned above, then the article can be considered to pass the F57 test. It has been found that since Ni is present in the greatest amount in melt-fabrication equipment (extruders and injection molding machines) which are commonly made of Inconel® Ni alloy in areas contacting the molten fluoropolymer, that the article will pass the F57 test when the Ni in the leach solution is amounts to no more than about 1 μg/m².

In still another embodiment of the present invention, it has been found that the fluoropolymer supplied, usually in pellet form, for the melt-fabrication into articles can have more than about 10 ppb of the sum of these metals and the molded article will still pass the F57 test. According to this embodiment, the extreme steps (and expense) for obtaining pure fluoropolymer are not necessary for the article melt-fabricated therefrom to perform satisfactorily in semiconductor processing service.

### DETAILED DESCRIPTION OF THE INVENTION

The fluoropolymers used in the present invention are preferably partially crystalline, i.e. have a melting point (temperature) and are melt-fabricable, i.e. can be fabricated from the molten state to form articles having sufficient toughness for semiconductor industry service. Preferred fluoropolymers are also perfluorinated polymers, i.e., copolymers of tetrafluoroethlyene (TFE) with perfluorinated monomer. The copolymer can include one or more of such perfluorinated comonomer. Examples of perfluorinated monomers include perfluoroolefins containing 3-8 carbon atoms, such as hexafluoropropylene (HFP), and perfluoro(alkyl vinyl ether) (PAVE), wherein the alkyl group contains 1 to 5 carbon atoms. Examples of such vinyl ethers include perfluoro(methyl, ethyl, and propyl vinyl ether). Copolymers of TFE and PAVE are commonly available as PFA copolymers, including MFA copolymer, which is a copolymer of TFE with perfluoro(methyl vinyl ether) and at least one additional vinyl ether, such as perfluoro(propyl vinyl ether). TFE/perfluoro(ethyl vinyl ether) copolymer is preferred because it crystallizes to give small spherulites upon solidifying from the molten state. Copolymers of TFE and HFP are commonly available as FEP copolymers. Typically the HFP content of the copolymer will be characterized by an hexafluoropropylene Index (HFPI) of about 2.0-5.3. HFPI is the ratio of two infrared absorbances measured on a film of the copolymer, which can be converted to wt % HFP by multiplying by 3.2 as disclosed in the paragraph bridging cols. 3 and 4 of U.S. Pat. No. 5,703,185. Preferably, the TFE/HFP copolymer contains at least one additional copolymerized monomer such as PAVE in an amount effective for the copolymer to exhibit an MIT flex life to be at least about 2000 cycles, preferably at least about 4000 cycles. Measurement of MIT flex life is disclosed in U.S. Pat. No. 5,703,185. Generally the amount of such additional monomer will be from about 0.2 to 3 wt %, based on the total weight of the copolymer. One preferred PAVE is perfluoro(propyl vinyl ether) and the most preferred PAVE is perfluoro(ethyl vinyl ether). The MFR of the FEP copolymers are determined in accordance with ASTM D2116-91a. The MFR of PFA copolymer is determined in accordance with ASTM D 3307-93. Typically the MFR of these copolymers will be from 1 to 50 g/10 min, more typically 2 to 35 g/10 min.

These fluoropolymers are normally supplied as molding pellets, wherein the fluoropolymer has been extruded as molten polymer into thin streams of fluoropolymer that are cut into short lengths, e.g. 1 to 3 mm long. Preferably these pellets are subjected to fluorine treatment such as disclosed in U.S. Pat. No. 4,743,658 to convert unstable end groups to the stable —CF₃ endgroup. Examples of unstable endgroups so-affected by the fluorine treatment are —CF₂CH₂OH, —CONH₂, —COF, and —COOH. Preferably, the sum of these unstable endgroups after fluorine treatment is no greater than 20/10⁶ carbon atoms, and with respect to the first three-named endgroups, preferably less than 6 such endgroups/10⁶ carbon atoms. The fluorine treatment, followed by the sparging of the fluorine-treated pellets as disclosed in U.S. Pat. No. 4,743,658, rid the fluoropolymer of extractable fluoride that might be leached from the article melt-fabricated from the pellets under the wet chemistry present in semiconductor manufacture, which would adversely affect semiconductor production.

The melt fabrication conditions for obtaining the articles, such as baskets or tubing, is carried out under conditions such that the surface of the article has smoothness characterized by an RMS roughness of no greater than 0.2 μm. Surface smoothness is determined as described in the Examples. Preferably, said surface has smoothness characterized by an RMS roughness of no greater than 0.1 μm. The melt-fabrication conditions will depend on the particular fluoropolymer used, its MFR and the particular melt-fabrication process. The TFE/PEVE copolymer is preferred because it is easiest to obtain the necessary smooth surface with this copolymer.

When the melt-fabrication is by injection molding, the mold cycle is such that for the melt temperature used and MFR of the fluoropolymer, the fluoropolymer can intimately contact the mold surface and the crystal growth in the molded article is minimized. Preferably the mold surface is polished so as to provide the surface smoothness desired for the molded article. The smoothness of the mold surface can be measured the same way as the surface smoothness of the article itself; use of the Zygo® Profilometer is disclosed in the Examples.

Extrusion conditions for obtaining extrudate having the desired surface smoothness will vary with equipment, the article being extruded, and the resin. However, the following general procedure can be described. Extrusion is begun at conditions where experience indicates that some melt fracture will be observable in the extrudate. This is seen as roughness and lack of gloss on the surface of interest, usually the inner surface when the extrudate is tubing. Then polymer melt temperature is increased and/or line speed reduced until melt fracture is not observable with the unaided eye, i.e., the surface of interest is glossy viewed at any angle. A sample of extrudate is taken at this point. Then polymer melt temperature is increased by about 5° F. (3° C.) and another sample is taken. This step may be repeated one or more times. The RMS roughness of the surface of interest of the sample is measured and the relation of RMS roughness to temperature is determined, e.g. graphically. Conditions that yield extrudate with RMS smoothness of about 0.2 μm or less are then selected and used for production of extrudate according to this invention.

In the case of extruded tubing, wherein it is only the interior surface of the tubing that comes into contact with semiconductor liquid processing chemicals, it is only the interior surface that this surface smoothness is required. The mandrel in the extrusion die, which forms the interior surface, should be polished at least to the smoothness desired for the interior surface of the tubing.

The smoothness of the desired surface of the extrudate can be confirmed by scanning electron microscopy (SEM) observation once the relationship to SEM appearance and F57 test results is established.

### EXAMPLES

In the following Examples, polymer feed pellets and extruded tubing of various fluoropolymers are examined for metal contamination and surface roughness by the following methods:

F57 testing of tubing Tubing is prewashed with ultrapure water (UPW) and then leached with UPW at 85+/−5° C. for 7 days. The leachate is analyzed by Inductively Coupled Plasma-Mass Spectrometry (ICP-MS) with the quantity of metals expressed in terms of area wetted by the leachate solution. The metals reported in these examples are Ni, Cr, and Fe with detection limits of 0.31, 0.36, 0.75 ug/m², respectively. This test is described in detail in SEMI F57-0301, SEMATECH.

Nitric Acid Leaching Method for Bulk Leachable Metals from resin pellets Polymer pellets are immersed in 12% ultrapure nitric acid at a ratio of 2 grams pellets per 1 gram acid. The pellets are not washed prior to exposure to the leaching acid. The pellets are leached for 24 hours at 60±5° C. The metals leached into the acid medium are analyzed by ICP-MS and the results reported in ppb relative to the polymer with detection limits of 0.1 ppb for Ni, Cr, and Fe. The leaching method results represent a minimum level of metals to be found in the polymer bulk of the molded article.

Laser Ablation Bulk Metals Laser Ablation-ICP-MS procedure for resin pellets or tubing provides a relative concentration of subsurface metals in a polymer matrix. Results are reported on a relative basis since the instrument is calibrated to a glass standard rather than a standard made from the same polymer matrix. The analysis procedure uses a Cetac LSX-100 Nd:YAG laser to vaporize succeeding depths of polymer. These burns were 175 μm wide and to a depth of 100 μm per pass. The vaporized polymer and metals are swept into an inductively coupled plasma torch and atomized. The atomized constituents are identified and quantified by mass spectrometry. The first burn of the part surface is ignored as being subject to surface contamination during sample preparation. The succeeding second and third passes are averaged to determine the relative amounts of metals present in the bulk of the polymer matrix.

The surface smoothness is determined by Zygo® profilometer according to the procedure described below. The profilometer measures undulations in the tubing surface and reports the results as RMS roughness values, which are measurements of surface roughness. The smaller the RMS roughness value, the smoother the surface. The curvature in the tubing surface is corrected so that the RMS roughness value does not include this curvation. The RMS roughness measurements are verified by scanning electron microscopy (SEM), i.e. visualization of the tubing surface on which the Zygo measurement is made and it is observed that the lower the RMS roughness value, the smoother the surface in SEM observation.

Zygo Roughness analysis The quantitative measures of the surface roughness of the tubings cited are performed with a Zygo NewView 5000 from Zygo Corporation, Middlefield Conn. USA. The instrument's 50× objective and 2× zoom are used to provide a 72 μm by 54 μm field of view of the inner wall of the tubes with a minimum pixel size of 0.11 μm. Typically images are collected at three different areas and the roughness parameters averaged together. The optical interference pattern produced by the reflected light from the sample surface forms the basis for the roughness measurement. The software used for the data analysis is Zygo Corporation's MetroPro 7.9.0. Since all the samples are cut from tubes, there is curvature in the images that must be removed or it will have an effect on the roughness parameters. As long as the features in the image are small compared to the curvature, as in this case, the background subtraction of a cylindrical surface will successfully remove the curvature without much effect on the roughness measurements. The roughness metric cited in these roughness measurements is the RMS or root-mean-square roughness of the tubing surface after curvature correction. The RMS is calculated as the standard deviation of the surface height at each pixel relative to the average for the entire surface.

The extruder used in making the tubing of the examples is a 1/5 inch single screw extruder with a length:diameter of 24:1, a compression ratio of 3:1, and a mixing head. A 1 inch in-line diebody is used with a 0.848 inch (21.5 mm) die and a 0.626 inch (15.9 mm) tip. The melt cone length is 1.75 inch (44.5 mm), the sizing sleeve is 0.343 inch (8.71 mm). The vacuum box contains water at 85° F. (30°) and is operated at 102-111 inches of water (25-27.6 kPa). The tubing is 0.5 inch (12.7 mm) outer diameter, 3/8 inch (0.95 mm) inner diameter.

The fluoropolymers used in the Examples have all been fluorine-treated in pellet form such that the sum of the above-mentioned four types of unstable endgroups is no greater than 20/10⁶ carbon atoms.

### Example 1

The fluoropolymer used in this Example is a copolymer of tetrafluoroethylene (TFE) with perfluoro(ethyl vinyl ether)(PEVE) having a melt MFR of 14.3 g/10 min as determined in accordance with ASTM D 3307-93. The fluoropolymer prior to extrusion, i.e. the fluoropolymer is in molding pellet form, analyzes as follows for metal contamination: Ni 7.2 ppb, Cr 3.4 ppb and Fe 6.0 ppb as determined by the nitric acid leaching method.

Extrusion temperature is 600° F. (315° C.), line speed is 3.9 ft/min (1.2 m/min) and drawdown (ratio) is 7. The surface smoothness of the extruded tubing is characterized by an RMS roughness of 0.04 μm. F57 analysis of the of the tubing surface reveals that Ni and Cr are not detectable in the leach solution and the amount of Fe detected in the leach solution is 0.81 μg/m². Thus, although there is considerable metal contamination in the bulk fluoropolymer, this metal contamination is virtually locked in the bulk of the tubing, thereby not presenting a metal contamination problem in semiconductor service.

The tubing extrusion process involves contact between the molten fluoropolymer and the Ni alloy (Inconel®) extruder surfaces (extruder barrel, extrusion die and extruder screw) which contaminate the surface of the tubing with metal. The virtual absence of metal contamination of the surface as revealed by analysis of the leach solution, indicates the effectiveness of the cleaning step in removing the surface metal contamination, permitted by the high smoothness of the surface.

Laser ablation analysis of the feed pellet and the tubing verifies that there was an increase in Ni content of the bulk polymer of the tubing during extrusion: resin, 0.23; tubing 0.57. This is a further indication that the metals buried within the polymer matrix do not participate significantly in the F57 leaching of the tubing.

For comparison purposes, a copolymer of TFE with perfluoro(propyl vinyl ether) (PPVE) having an MFR of 13.6 g/10 is extruded into tubing by the same procedure as used on the TFE/PEVE copolymer described above. This TFE/PPVE copolymer (pellet form) has a higher bulk purity than the copolymer as determined by the nitric acid leaching method: Ni 3.5 ppb, Cr 1 ppb, and Fe 3.8 ppb. Extrusion temperature is 600° F. (315° C.), line speed is 3.2 ft/min (0.98 m/min) and drawdown is 7. The surface of the extruded tubing has the same appearance as that of the tubing of the TFE/PEVE copolymer, i.e. the surface is smooth and glossy in appearance. The smoothness of the surface of the TFE/PPVE tubing, is characterized by an RMS roughness of 0.31 μm. F57 analysis of the tubing surface reveals that the Ni contamination in the leach solution is 1.3 μg/m², which exceeds the limit for this metal. This contamination is more than 4 times the Ni contamination from the TFE/PEVE copolymer tubing, despite the TFE/PPVE copolymer tubing being made of copolymer that has initially one half the amount of Ni contaminant in the feed resin pellets. Analysis of laser ablated TFE/PPVE tubing reveals a similar increase in bulk Ni metal contamination during extrusion and still resulting in a lower level of Ni contamination in the polymer bulk: resin 0.13 and tubing 0.43. The lower bulk contamination of the TFE/PPVE copolymer carried over into lower bulk contamination of the extruded tubing. The failure of the TFE/PPVE copolymer tube to pass the leach contamination test of F57 is attributed to the much rougher surface of the TFE/PPVE copolymer tubing.

Similar results are achieved when a different TFE/PPVE copolymer is used, having an MFR of 13.0 g/10 min, with this copolymer being of even higher bulk purity than the TFE/PPVE copolymer described above, i.e. containing the following: Ni 2.8 ppb, Cr 1.2 ppb, and Fe 3.2 ppb as determined by the nitric acid leaching method. Extrusion temperature is 600° F. (315° C.), line speed is 3.2 ft/min (0.98 m/min) and the drawdown is 7. The surface smoothness of the tubing is characterized by an RMS roughness of 0.27 μm, and F57 analysis reveals the presence of 3 μg/m² in the leach solution, far in excess of the limit allowed for this metal. In this case the extrusion process did not significantly increase the Ni in the subsurface of the tubing, as determined by laser ablation: resin 0.13 and tubing 0.13. The increase in Ni as determined by the F57 is due to the combination of increased Ni as a surface contaminant and the inability to wash the surface due to the roughness of the surface.

It has been found that when the surface smoothness is about 0.2 μm that the Ni content in the leach solution varies about 1 μg/m², the F57 limit for Ni. Still further smoother surfaces of 0.10 μm RMS roughness and below are more washable and reduce the F57 leachable Ni to comfortably below the F57 tubing limit.

### Example 2

In this Example, the fluoropolymer is TFE/PPVE copolymer having an MFR of 2.1 g/10 min. Extrusion temperature is 600° F. (315° C.), line speed is 0.8 ft/min (0.24 m/min) and drawdown is 7, providing a surface smoothness for the extruded tubing characterized by an RMS roughness of 0.09 μm and providing the following metal concentration in the F57 leach solution: Ni 0.6 μg/m², Cr not detected, and Fe 2.2 μg/m². The bulk metal contamination of this copolymer is as follows: Ni 5.5 ppb, Cr 2.0 ppb, and Fe 8.0 ppb as determined by the nitric acid leaching method.

Similar results (0.61 μg/m² of Ni in the leach solution) are obtained under the same extrusion conditions for a TFE/PPVE copolymer (similar bulk metal contamination) having an MFR of 2.09 g/10 min and the resultant tubing has a surface smoothness characterized by an RMS roughness of 0.10.

Similar results (0.52 μg/m2 of Ni in the leach solution) are obtained under the same extrusion conditions for a TFE/PPVE copolymer having an MFR of 1.97 g/10 min having a bulk metal contamination of Ni 0.3 ppb, Cr 0.2 ppb, and Fe 1.0 ppb and the resultant tubing has a surface smoothness of characterized by an RMS roughness of 0.17 μm.

What is claimed is:

1. Process for determining metal contamination arising from an article melt-fabricated from fluoropolymer, said process comprising (a) subjecting said article to cleaning so as to remove said metal present on the surface of said article, (b) subjecting the resultant cleaned article to leaching solution, and (c) determining the concentration of said metal in the leaching solution, the surface of said article having smoothness characterized by an RMS roughness of no greater than about 0.2 μm, thereby facilitating the removal of the metal contamination from the surface of said article by said cleaning, whereby the concentration of said metal determined in step (c) is not affected by the said metal present on the surface of said article.

2. The process of claim 1, wherein said surface has smoothness characterized by an RMS roughness of no greater than about 0.1 μm.

3. Process for melt-fabricating fluoropolymer into an article, comprising, carrying out said melt-fabricating to obtain said article having a smoothness characterized by an RMS roughness of no greater than about 0.2 μm, whereby said article passes the F57 test.

4. The process of claim 3 wherein said carrying out of said melt-fabrication is injection molding in a mold and the surface of said mold is polished so as to provide said surface smoothness.

5. The process of claim 3 wherein said carrying out of said melt-fabrication is extruding and the extrusion rate and extrusion temperature are selected to avoid melt fracture and provide said surface smoothness.

6. The process of claim 3 wherein said article contains greater than about 10 ppb of said metal.
